(19) United States
(12) Patent Application Publication
(10) Pub. No.: US 2024/0407591 A1
(43) Pub. Date: Dec. 12, 2024

(54) PORTABLE COOKING DEVICE

(71) Applicant: Francois Gerber, Duluth, MN (US)

(72) Inventor: Francois Gerber, Duluth, MN (US)

(21) Appl. No.: 18/672,575

(22) Filed: May 23, 2024

Related U.S. Application Data
(60) Provisional application No. 63/469,206, filed on May 26, 2023.

(51) Int. Cl. A47J 33/00; A47J 37/07

(52) U.S. Cl. CPC A47J 33/00; A47J 37/0704

(57) ABSTRACT

A portable cooking device includes a base member having a heat tray and a pair of legs. A heat diffuser having a series of raised wall segments and hollow vertical channels is positioned onto the heat tray, and a series of directed venting openings comprising a plurality of side openings and a plurality of upper openings are located along the legs. A cooking plate having a front door slides along the top surface of the heat tray, and a malleable and resilient cover is connected to the base member. The cover including a plurality of tabs for engaging the upper openings on the top surface of the legs. When positioned onto the base member, a portion of each opening remains unobstructed and functions to direct heat along an inside surface of the cover for engaging the top surface of the cooking plate when the device is in the closed position.

### CROSS-REFERENCE TO RELATED APPLICATIONS

This application claims the benefit of U.S. application Ser. No. 63/469,206 filed on May 26, 2023, the contents of which are incorporated herein by reference.

### TECHNICAL FIELD

The present invention relates generally to camping and backpacking accessories, and more particularly to a portable cooking device functionable as a grill, stove, and convection oven.

### BACKGROUND

The statements in this section merely provide background information related to the present disclosure and may not constitute prior art.

Many times, when participating in outdoor recreational activities like backpacking, or camping, it is desirable for a user to carry cooking equipment with them. In this regard, the two most common types of portable cooking devices are the camping stove and the campfire grill.

Most conventional camping stoves include a cooking surface having at least one burner that is connected to a pressurized fuel tank. Depending on the design of the stove, the user will connect the fuel tank to the burner to provide the fuel to the burner which creates the heat source for cooking. Although useful, such devices have several disadvantages. For example, the requirement of a fuel tank occupies valuable space and adds considerable weight to the user's backpack. Moreover, if the fuel tank runs out of fuel on the trip, the camping stove will no longer function.

Conversely, campfire grill assemblies typically include a support post that is positioned into the ground adjacent to a campfire and permit a user to rotate a cooking rack above a campfire to cook items on the rack. Although useful for simple outdoor grilling, these devices also suffer from many drawbacks. For example, the orientation of the rack to the fire typically results in the food items being burned or heavily smoked due to the close and direct exposure to the flames from the campfire. Additionally, because an open fire is required, such devices cannot be used within shelters or indoors. Further, such devices limit users to simple grilling, and cannot act as an oven which is especially useful when camping for long periods of time wherein a variety of cooking methods and preparations is desirable.

Accordingly, it would be beneficial to provide a portable cooking device that can be used in both an indoor and outdoor situation and that does not suffer from the drawbacks noted above.

### SUMMARY OF THE INVENTION

The present invention is directed to a portable cooking device. One embodiment of the present invention can include a base member having a horizontally oriented heat tray for receiving heat from an external heat source, and a pair of legs for positioning the heat tray a set distance from the heat source. A heat diffuser can be positioned within an indentation along a central portion of the heat tray. The diffuser can preferably include a series of raised wall segments arranged in a diffusion optimized rectilinear pattern for diffusing heat evenly along a 360-degree area. The diffuser can also include a plurality of hollow vertical channels for diffusing heat vertically from the diffuser.

In one embodiment, a series of directed venting openings can be positioned along the pair of legs. The directed venting openings can include a series of side openings positioned along the inside facing walls of the legs at a location adjacent to the top surface of the heat tray, and a plurality of upper openings positioned along the top surface of the legs.

In one embodiment, a cooking plate can be positioned along the top surface of the heat tray. The cooking plate can include a plurality of lags for positioning the bottom surface of the cooking plate above the diffuser, and the cooking plate can be connected to a front door. The cooking plate can selectively slide along the cooking plate to transition between an open position and a closed position.

In one embodiment, a cover can be provided that transitions between a flat orientation and a dome-shaped orientation. The cover can include a plurality of tabs that are positioned along the side edges for engaging the upper openings on the top surface of the legs. When positioned onto the base member, a portion of each top opening remains unobstructed and functions to direct heat along an inside surface of the cover for engaging the top surface of the cooking plate when the device is in the closed position.

In one embodiment, a back door can be secured onto the back side of the base member. The back door can pivot between a fully closed position, one or more intermediate positions and a fully closed position, and can aid a user in regulating a temperature of the device during operation.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is an exploded parts view of one embodiment of the portable cooking device that is useful for understanding the inventive concepts disclosed herein.

FIG. 2A is a top perspective view of the base member of the portable cooking device in accordance with one embodiment of the invention.

FIG. 2B is a bottom perspective view of the base member of the portable cooking device in accordance with one embodiment of the invention.

FIG. 3A is a top perspective view of the heat diffuser of the portable cooking device in accordance with one embodiment of the invention.

FIG. 3B is a perspective view of the heat diffuser and base member of the portable cooking device in accordance with one embodiment of the invention.

FIG. 4A is a top perspective view of the cooking plate of the portable cooking device in accordance with one embodiment of the invention.

FIG. 4B is a perspective view of the cooking plate and base member of the portable cooking device in accordance with one embodiment of the invention.

FIG. 5A is a top perspective view of the cover of the portable cooking device in accordance with one embodiment of the invention.

FIG. 5B is a perspective view of the cover and base member of the portable cooking device in accordance with one embodiment of the invention.

FIG. 5C is a front view of the portable cooking device where the front door is removed for ease of illustration in accordance with one embodiment of the invention.

FIG. 6A is a perspective view of the portable cooking device in the closed position, in accordance with one embodiment of the invention.

FIG. 6B is a perspective view of the portable cooking device in the open position, in accordance with one embodiment of the invention.

FIG. 6C is a perspective view of the portable cooking device in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described herein, a “unit” means a series of identified physical components which are linked together and/or function together to perform a specified function.

As described throughout this document, the term “about” “approximately” “substantially” and “generally” shall be used interchangeably to describe a feature, shape, or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the terms “resilient” and “shape memory” are used to define the ability of a component to maintain a particular shape and/or to attempt to return to the particular shape after being bent, folded, twisted, or otherwise manipulated.

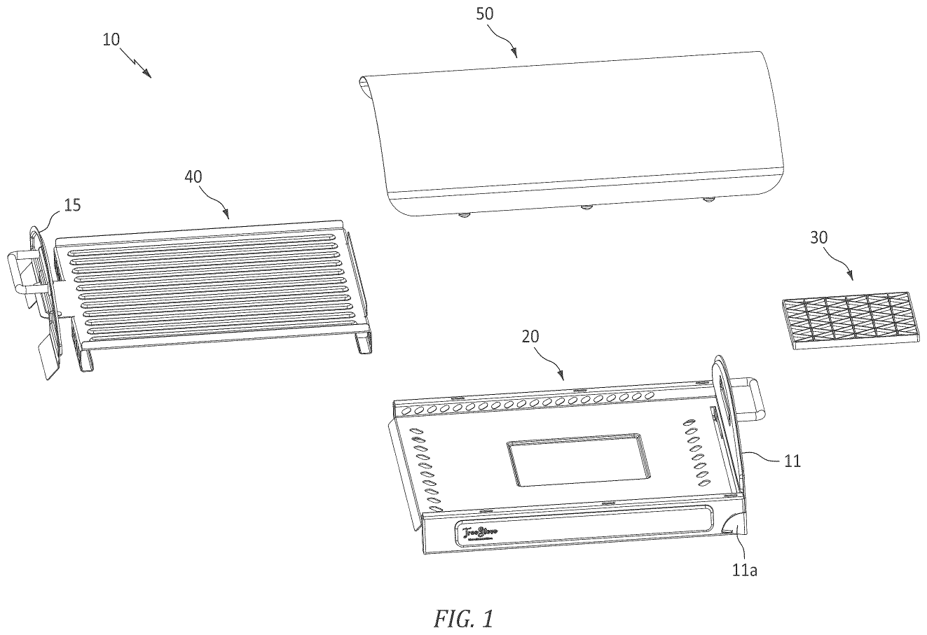

FIGS. 1-6C illustrate one embodiment of a portable cooking device 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As will be described below, the inventive cooking device is designed to be portable in nature so as to be carried in a camping backpack or other such container. The device can be positioned so as to receive heat from an external heat source such as charcoal, propane/butane burners, or a campfire, for example. In either instance, the inventive cooking device can allow a user to cook any number of different items by using the device as a grill, stove or convection oven, thus greatly elevating the camping experience. Moreover, depending on the heat source, the device can be used in both an indoor and outdoor environment.

As shown in the exploded parts view of FIG. 1, one embodiment of the device 10 can include, essentially, a base member 20, a heat diffuser 30, a retractable cooking plate 40, and a cover 50.

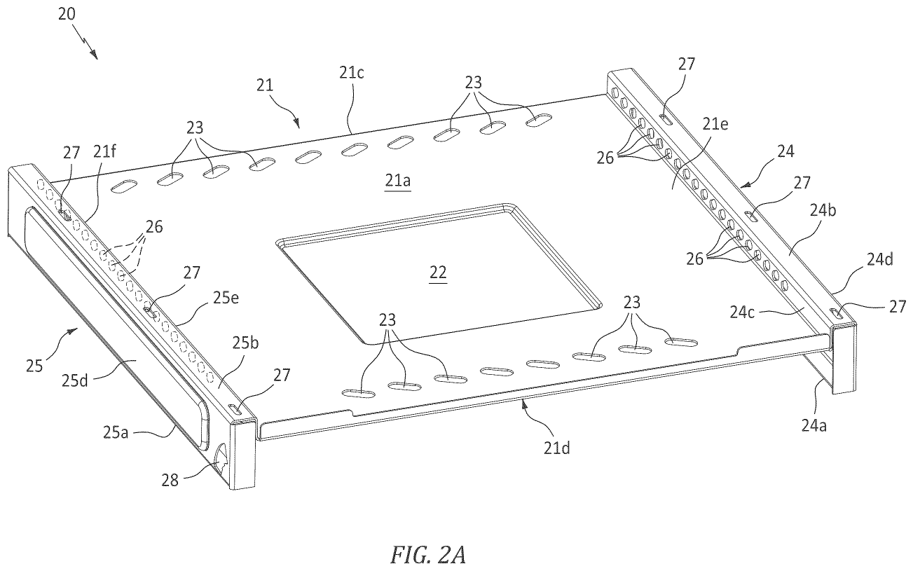

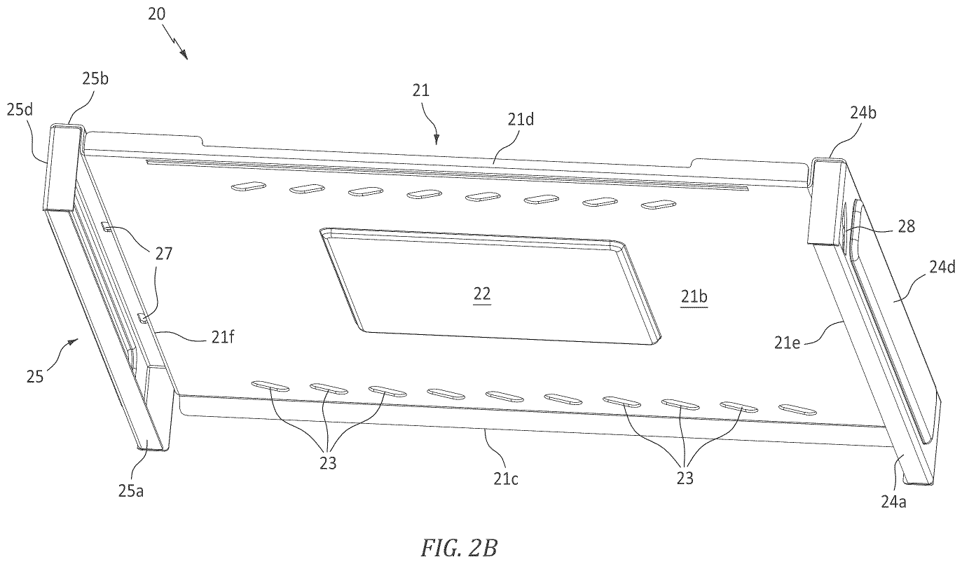

The base member 20 of the device can function to house and support the device components in the manner described herein. As shown best at FIGS. 2A and 2B, one embodiment of the base member can include a generally rectangular-shaped heat tray 21 having a top surface 21a, a bottom surface 21b, a front edge 21c, a back edge 21d and a pair of side edges 21e and 21f. In one embodiment, a recession 22 is positioned along the center of the tray and can function to receive and position the below described diffuser 30, and a plurality of tray openings 23 can be positioned along the tray surface adjacent to the front and back edges.

In one embodiment, two legs 24 and 25 can be positioned along the side edges of the heat tray 21. As shown, each of the legs can include respective bottom ends 24a and 25a that extend downward from the sides of the tray, upper ends 24b and 25b that extend upward from the sides of the tray, inside facing sidewalls 24c and 25c, and outside facing sidewalls 24d and 25d, respectively.

In one embodiment, a plurality of directed venting elements are provided along the legs 24 and 25. In the illustrated embodiment, the directed venting elements can include a plurality of side openings 26 that are positioned along the inside facing sidewalls of each leg at a location slightly above and adjacent to the side edges of the heat tray 21, and a series of upper openings 27 that are positioned along the upper end of each of the legs 24 and 25.

As will be described below in detail, the legs 24 and 25 serve dual purposes as they 1) function as a stand to position the heat tray a set height from an external heat source, and 2) directly vent heat energy upward along the interior surface of the domed-shape cover to allow the heat to ultimately be projected downward onto the top surface of the cooking plate for even convection cooking. In this regard, the design of the device is such that the tray openings 23 receive and vent about 30 percent of the indirect heat energy from the heat source onto the bottom of the cooking plate, while the directed venting elements direct about 70 percent of the indirect heat energy from the heat source and the diffuser onto the top surface of the cooking plate via the dome. Such elements are critical for ensuring smooth even convection baking.

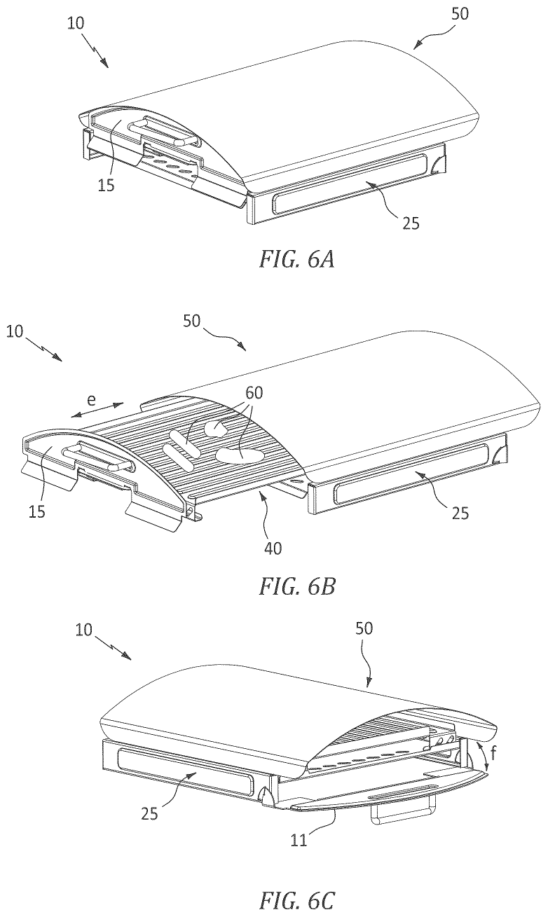

In one embodiment, two slotted openings 28 can be positioned along the back ends of the legs 24 and 25. Each of the slotted openings can function to receive and engage a pair of protrusions 11a positioned along each side of the rear oven door 11 (See FIG. 1). The slotted openings and protrusions allowing the rear oven door to be pivotally secured to the base member and to transition between a fully open position (e.g., door is in a horizontal orientation), a fully closed position (e.g., door is in a vertical orientation) and any number of intermediate positions (e.g., door is in a diagonal position) between fully open and fully closed positions as shown below at FIG. 6C. Such a feature advantageously allows the rear door to selectively trap or release heat within the device to regulate the convection cooking temperature.

In the preferred embodiment, the base member will be constructed from a metal such as titanium, or stainless steel, for example, however any number of other materials such as different types of metals, metal alloys, or composite materials, for example, that are suitable for prolonged exposure heat in excess of 300-800 degrees Fahrenheit, for example, without deforming are also contemplated. Although described above with regard to a rectangular shape, this is for illustrative purposes only, as the base member may be constructed to include any number of different shapes and sizes.

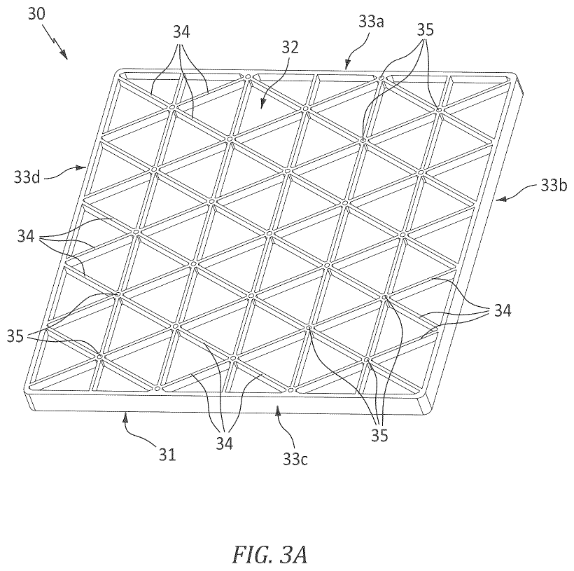

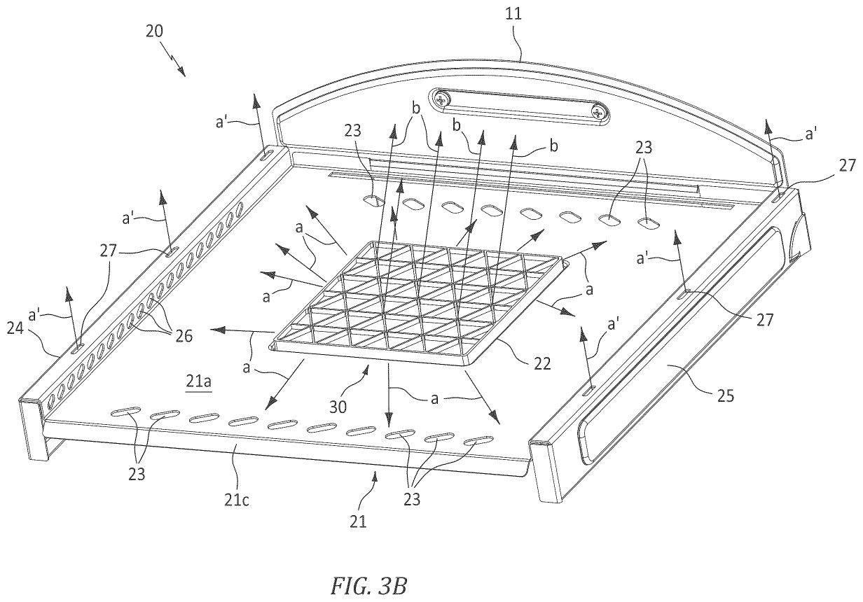

FIGS. 3A and 3B illustrate one embodiment of the heat diffuser 30 which can function as a radiant heat absorber and distributor for use with the device 10. As shown, the diffuser can include a generally square-shaped member having a smooth flat bottom surface 31, a top surface 32, a plurality of side walls 33a, 33b, 33c and 33d.

The diffuser is optimized to present the largest surface area possible for directing heat outward and away in all directions. As such, in the preferred embodiment, a plurality of raised triangular-shaped wall segments 34 extend upward from the top surface. Each of the wall segments are separated by tubular-shaped openings 35 extending vertically from the top surface 32 to the top of the wall segments 34.

The diffuser can include an outer shape and size that is complementary to the shape and size of the recession 22 on the heat tray 21 so as to be positioned therein when in use. Moreover, the positioning of the diffusing wall segments 34 and openings 35 is a critical feature as the rectilinear pattern functions to evenly direct and distribute heat away from the diffuser in a 360-degree area (see arrows a) so as to be received and distributed by the venting elements of the legs 24 and 25 (see arrows a′), and the below described cooking plate 40. Likewise, each of the openings 35 function to channel and direct heat in a purely vertical direction (see arrow b), so as to directly engage the bottom of the cooking plate.

In the preferred embodiment, the heat diffuser will be constructed from copper; however, any number of other heat conductive materials are also contemplated. Although described above with regard to particular shape or size, other embodiments are contemplated wherein the diffuser can be provided with a different shape or size.

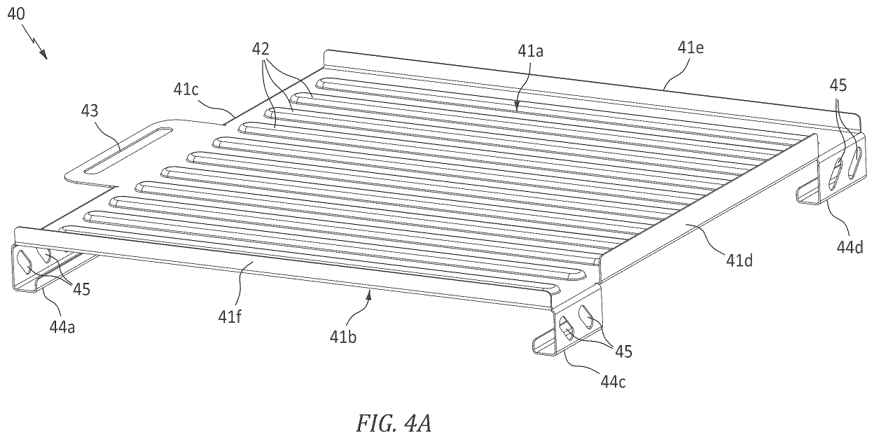

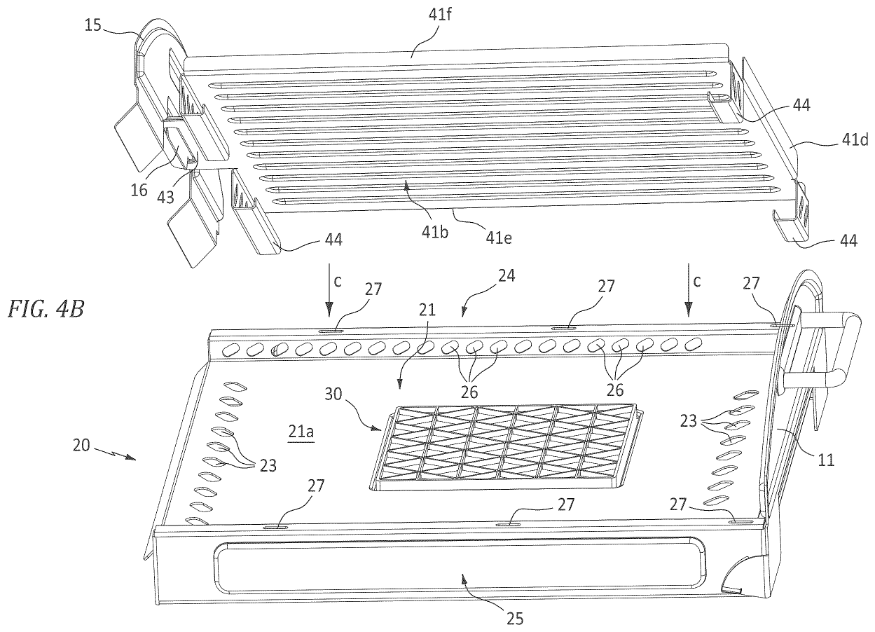

As shown best at FIGS. 4A and 4B, one embodiment of cooking plate 40 can include a generally rectangular-shaped member having a top surface 41a, a bottom surface 41b, a front edge 41c, a back edge 41d and a pair of side edges 41e and 41f. In one embodiment, a plurality of protruding channels 42 are positioned along the top surface of the plate and function in a manner similar to grill grates when food is positioned directly onto the plate. Additionally, an elongated opening 43 can be positioned along a protruding section on the front edge 41c for receiving and engaging a protrusion extending 16 from the bottom edge of the front oven door 15.

The cooking plate can be lowered onto the top of the heat plate 21 (see arrow c) and can include a plurality of legs 44 that extend downward from the bottom surface of the plate along the front and back edges. Each of the legs can function to provide physical separation between the bottom surface of the cooking plate and the top surface 21a of the heat tray 21 to allow the heat from the diffuser 30 and the openings 23 to be evenly distributed along the entire bottom surface 41b. In the preferred embodiment, the legs of the plate will include a smooth flat bottom surface for allowing the plate and legs to slide along the top surface of the heat tray via a pulling motion on the front door 15 to transition the cooking device between an open and closed position as is shown below at FIG. 6B.

Additionally, each of the legs can also include a plurality of horizontally oriented openings 45 which can function as secondary directed venting elements to further channel heat from the tray upward to allow the heat to project downward onto the top of the cooking plate for even convection cooking.

In the preferred embodiment, the cooking plate will also be constructed from a metal such as titanium, or stainless steel, for example, however any number of other materials such as different types of metals, metal alloys, or composite materials, for example, that are suitable for prolonged exposure heat in excess of 300-800 degrees Fahrenheit, for example, without deforming are also contemplated. Although described above with regard to a rectangular shape, this is for illustrative purposes only, as the cooking plate may be constructed to include any number of different shapes and sizes.

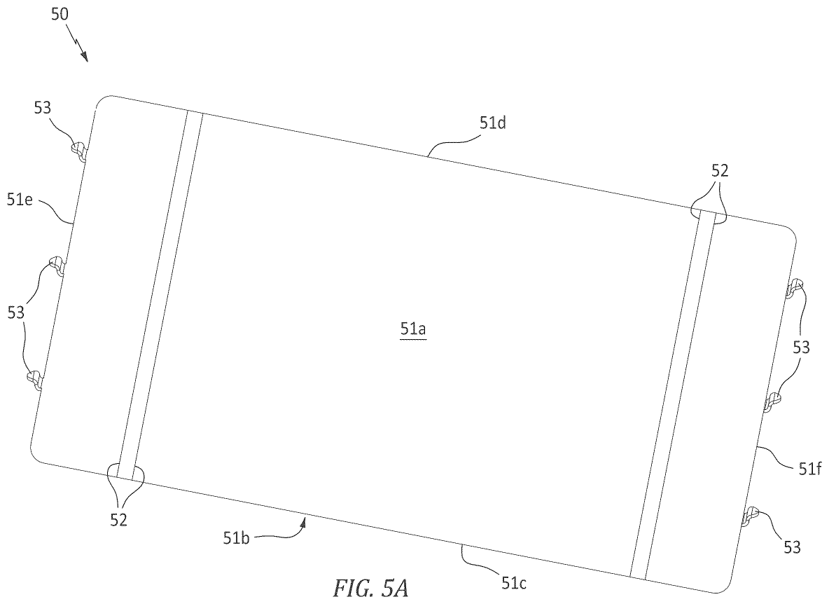

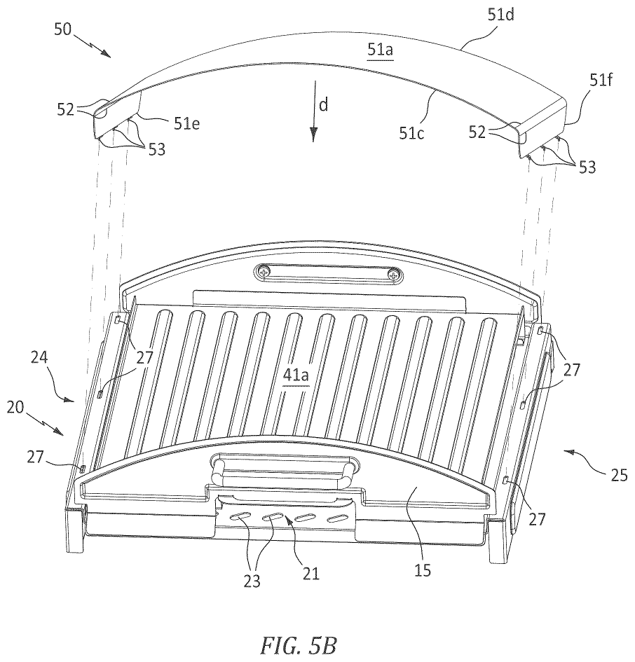

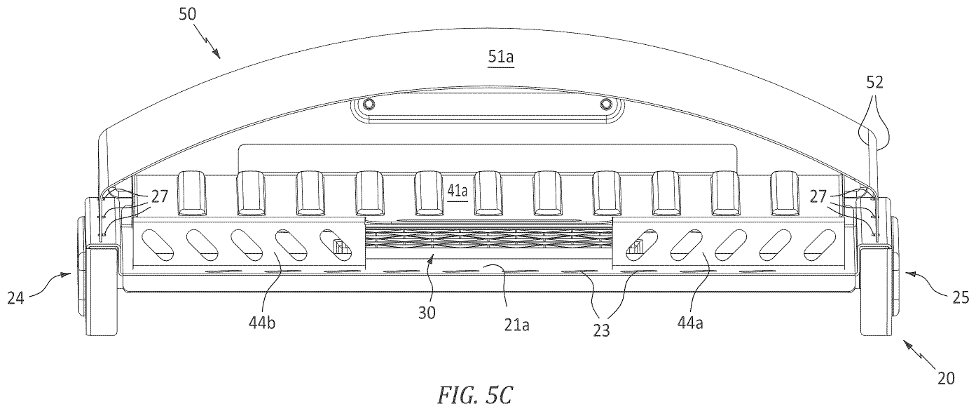

FIGS. 5A and 5B illustrate one embodiment of the oven cover 50 in the flat and dome-shaped configurations, respectively. As shown, the cover can include an elongated, generally rectangular-shaped member having a top surface 51a, a bottom surface 51b, a front edge 51c, a back edge 51d and a pair of side edges 51e and 51f. In the preferred embodiment, two living hinges 52 are positioned along the sides of the cover body at locations adjacent to the side edges.

In one embodiment, a plurality of locking tabs 53 can extend outward from each of the side edges 51e and 51f. Each of the tabs can be positioned at locations complementary to the upper openings 27 along the upper end of each of the base legs 24 and 25 and can be removably secured therein as the cover is lowered (see arrow d) onto the base member 20.

In preferred embodiment, the cover is constructed from a thin (e.g., 1 mm-5 mm) resilient malleable metal such as stainless steel, for example, having shape memory. In this regard, the cover can be biased toward the flat orientation shown in FIG. 5A, so as to occupy a minimal amount of space within a users backpack during transport and/or when not in use.

As shown at FIG. 5B, when assembling the device for use, the user can simply bend the cover which results in the middle portion forming a curved dome shape, and the sides of the cover (between the hinges and the side edges) being positioned vertically. In this position, the tabs 53 will be aligned with the openings 27 and can be positioned therein.

When secured to the base in this manner, the shape memory of the material attempting to return the cover to the flat orientation will apply tension onto the legs 24 and 25, thus locking the tabs within the openings 27. Such a feature will securely position the front end of the cover against the top edge of the front door, and the back end of the cover against the top edge of the rear door (See FIG. 6A).

As shown at FIG. 5C, wherein the front door 15 is removed for ease of illustration, it is specifically noted that the positioning of the tabs within the openings 27 does not occupy or otherwise block the entire opening. To this end, about 75% of each opening 27 remains free and open adjacent to the inside surface 51b of the cover 50 to distribute heat upward along the inside surface of the cover as described above to achieve even convection cooking. Such a feature is a critical feature of the inventive concepts.

FIGS. 6A-6C illustrate one embodiment of the device 10 in operation in the fully assembled position. As shown by arrow e, the front door 15 can slide the cooking plate 40 in and out from beneath the cover to permit a user to easily access items 60 being cooked on the tray. Likewise, the rear door 11 can pivot (see arrow f) to transition between a fully open position, a fully closed position, and any number of intermediate positions to selectively trap or release heat, thus assisting a user in regulating the convection cooking temperature.

As to a further description of the manner and use of the present invention, the same should be apparent from the above description. Accordingly, no further discussion relating to the manner of usage and operation will be provided.

As described herein, one or more elements of the device 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A portable cooking device, comprising:
a base member having a heat tray and a pair of legs, said heat tray being configured to receive heat from an external heat source;
a cooking plate that is configured to be positioned above a top surface of the heat tray;
a cover that is removably connected to the base member;
a front door that is configured to be connected to the cooking plate; and
a back door that is configured to be connected to the base member,
wherein the cooking plate is configured to slide between a closed position and an open position via a pulling motion on the front door.

2. The device of claim 1, further comprising:
a heat diffuser that is configured to be positioned along the heat tray.

3. The device of claim 2, further comprising:
an indentation along the heat tray, said indentation having a shape and a size that is complementary to a shape and a size of the heat diffuser.

4. The device of claim 3, wherein the heat diffuser is removably positioned within the indentation.

5. The device of claim 2, further comprising:
a plurality of openings that are positioned along the heat tray, said openings being configured to direct heat from the external heat source onto a bottom surface of the cooking plate.

6. The device of claim 1, further comprising:
a plurality of cooking plate legs that extend downward from a bottom surface of the cooking plate.

7. The device of claim 6, wherein each of the plurality of cooking plate legs include a flat bottom surface that is configured to engage the top surface of the heat tray.

8. The device of claim 7, wherein the front door is removably connected to the cooking plate.

9. The device of claim 1, wherein the cover is configured to transition between a flat orientation and a dome-shaped orientation.

10. The device of claim 9, further comprising:
a plurality of tabs that are positioned along the cover,
wherein each of the plurality of tabs being configured to engage the base member to secure the cover to the base member.
